(19) United States
(12) Patent Application Publication
(10) Pub. No.: US 2023/0396538 A1
(43) Pub. Date: Dec. 7, 2023

(54) CONTEXT-AWARE ROUTING FOR SD-WAN

(71) Applicant: VMware, Inc., Palo Alto, CA (US)

(72) Inventors: Santosh Pallagatti Kotrabasappa, Bangalore (IN); Abhishek Goliya, Pune (IN); Sajan Liyon, Bengaluru (IN); Sairam Veeraswamy, Coimbatore (IN); Sumit Mundhra, Burnaby (CA)

(21) Appl. No.: 17/833,555

(22) Filed: Jun. 6, 2022

(51) Int. Cl. H04L 45/42; H04L 45/12; H04L 45/24; H04L 47/125

(52) U.S. Cl. CPC H04L 45/42; H04L 45/123; H04L 45/24; H04L 47/125

(57) ABSTRACT

Some embodiments provide a method for implementing context-aware routing for a software-defined wide-area network (SD-WAN). The method is performed at a particular SD-WAN edge forwarding element (FE) connected to a particular cloud datacenter. The method receives a message specifying a weight for a virtual network address associated with a set of application resources distributed across multiple cloud datacenters including the particular cloud datacenter. The method converts the specified weight into a route weight for the SD-WAN. The method provides the converted route weight to a set of SD-WAN edge FEs connected to a set of branch networks, and each SD-WAN edge FE in the set of SD-WAN edge FEs uses the provided route weight to calculate a total cost for routing data messages directed to the virtual network address to the particular cloud datacenter.

### BACKGROUND

Today, load balancers are deployed in cloud datacenters to ensure incoming connections are load balanced across multiple instances that provide a service within the cloud datacenters. Typically, each cloud datacenter has its own virtual network address, and based on geo-location, DNS will resolve to the nearest datacenter's virtual network address. However, this may cause uneven resource utilization across the datacenters (e.g., cloud datacenters of a multicloud), and can lead to latency in the service, and/or service unavailability while other cloud datacenters may be underutilized.

### BRIEF SUMMARY

Some embodiments of the invention provide a method of implementing context-aware routing for a software-defined wide-area network (SD-WAN). The SD-WAN, in some embodiments, is formed by a set of SD-WAN edge forwarding elements (FEs) that connects branch networks (or other enterprise networks) to a set of cloud datacenters across which application resources are distributed, with the set of application resources reachable at each of these cloud datacenters using the same virtual network address (e.g., the same virtual IP address). The SD-WAN edge FEs at the branch networks install routes for the virtual network address with next hops at each of the cloud datacenters, with these routes having different costs based on various factors. When an SD-WAN edge FE receives a data message for a new connection directed to the virtual network address, the FE selects the route with the lowest total cost (i.e., the highest priority).

In this context, the SD-WAN edge FEs at the branch networks use a combination of route weights from a combination of sources to identify total costs for routing data messages directed to the virtual network address to the different cloud datacenters across which the application resources are distributed. These route weights, in some embodiments, include geolocation route weights based on physical distances between the branch networks and the cloud datacenters, datacenter route weights that are updated in real time indicating capacity of the different cloud datacenters, and latency route weights indicating latencies for sending data messages between the branch networks and the cloud datacenters.

The SD-WAN edge FEs located at the branch networks, in some embodiments, receive the geolocation route weights from an SD-WAN controller. The geolocation route weights correspond to physical distances between the branch networks and the cloud datacenters (e.g., such that larger physical distances are expressed as larger route weights). The SD-WAN controller generates these geolocation route weights as a matrix of route weights for each link between one of the branch networks and one of the cloud datacenters, such that each branch network SD-WAN edge FE receives the geolocation route weights for its link to each of the cloud datacenters.

In addition, the SD-WAN edge FEs at the branch networks receive datacenter route weights from the SD-WAN edge FEs at the cloud datacenters. These datacenter route weights express the capacity of the application resources at the datacenter. As described further below, the SD-WAN edge FEs at the datacenters receive information for computing the route weights from load balancers at the datacenter. In some embodiments, larger route weights indicate less current capacity at the datacenter (i.e., a higher total cost, or lower priority, for the corresponding route).

In some embodiments, the SD-WAN edge FE at the branch network also uses a latency route weight to calculate the total cost for each route, such that each total cost is a combination of the geolocation route weight from the controller, the datacenter route weight from the SD-WAN edge FE at the cloud datacenter, and the latency route weight. The total cost may be computed in different ways in different embodiments (e.g., using one route weight as a primary cost with others as tiebreakers, adding the route weights together, etc.). The latency route weights are computed by the SD-WAN edge FE at the branch network, in some embodiments, based on latency measurements between the SD-WAN edge FE at the branch and the SD-WAN edge FEs at the cloud datacenters. These measurements may be based on actual data traffic sent between the branch networks and the cloud datacenters or on separate measurements (e.g., control messages sent for the purposes of computing the latency).

In some embodiments, the geolocation route weight from the controller is a static value (because the physical distance is constant) while the datacenter route weight and latency route weights are updated in real-time. The SD-WAN edge FE at the branch network may periodically update the total cost for a route based on real-time changes to either the latency route weight or the datacenter route weight. When the total cost of one or more of the routes at the SD-WAN edge for a particular branch network is changed such that a different one of the routes has the lowest total cost (highest priority), existing connections are not re-routed from one datacenter to another but any new connections originating from that branch network to the set of resources are routed to the datacenter whose route now has the lowest total cost.

As indicated, in some embodiments the datacenter route weight associated with a route between a particular branch network and a particular cloud datacenter is received from the SD-WAN edge FE connected to the particular cloud datacenter. The SD-WAN edge FE connected to each cloud datacenter receives a message specifying a weight metric for the virtual network address from the cloud datacenter and converts the specified weight into the datacenter route weight for the SD-WAN. The SD-WAN edge FE at the cloud datacenter then provides the converted route weight to the SD-WAN edge FEs at each of the branch networks so that these FEs can use the datacenter route weight to calculate the total costs for their respective routes to the particular cloud datacenter.

In some embodiments, the message received by the particular SD-WAN edge FE at the cloud datacenter is a border gateway protocol (BGP) message that advertises the virtual network address and specifies the weight as a BGP community attribute, though other embodiments use other routing protocols or other types of messages to communicate the weight. In some embodiments, the SD-WAN edge FE converts this specified weight to a route weight in a type, length, value (TLV) format (e.g., a VeloCloud Routing Protocol (VCRP)) route weight. In some embodiments, the message is received from a load balancer executing within the cloud datacenter (e.g., on an FE that connects the cloud datacenter to the SD-WAN). The load balancers of some embodiments are responsible for adjusting the weight metrics for each of the cloud datacenters based on the capacity of the application resources at their respective datacenters. That is, when the application resources at a particular cloud datacenter are overutilized, the load balancer at that datacenter can increase the weight metric so that subsequent new connections for the application resources are less likely to be forwarded to that datacenter.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates a set of branch networks connected to a set of cloud datacenters through an SD-WAN of some embodiments.

FIG. 2 conceptually illustrates a process of some embodiments for installing routes to cloud datacenters across which a set of application resources is distributed.

FIG. 3 illustrates an SD-WAN of some embodiments through which an SD-WAN controller provides geolocation route weights to the SD-WAN edge FEs.

FIG. 4 conceptually illustrates a geolocation route weight matrix for a set of branch networks and a set of cloud datacenters, in some embodiments.

FIG. 5 illustrates the forwarding, in some embodiments, of initial datacenter route weights from the SD-WAN edge FEs at the cloud datacenters to the SD-WAN edge FEs at the branch networks.

FIG. 6 conceptually illustrates a workflow of some embodiments between a cloud datacenter and an SD-WAN edge FE connected to the cloud datacenter.

FIG. 7 conceptually illustrates a process of some embodiments for providing the datacenter route weights to SD-WAN edge FEs at the branch networks.

FIGS. 8A-8C conceptually illustrate an example of an SD-WAN across which sets of existing and new connections are established between a branch network and a set of cloud datacenters based on the total cost to route data messages between the branch network and each of the cloud datacenters.

FIG. 9 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method of implementing context-aware routing for a software-defined wide-area network (SD-WAN). The SD-WAN, in some embodiments, is formed by a set of SD-WAN edge forwarding elements (FEs) that connects branch networks (or other enterprise networks) to a set of cloud datacenters across which application resources are distributed, with the set of application resources reachable at each of these cloud datacenters using the same virtual network address (e.g., the same virtual IP address). The SD-WAN edge FEs at the branch networks install routes for the virtual network address with next hops at each of the cloud datacenters, with these routes having different costs based on various factors. When an SD-WAN edge FE receives a data message for a new connection directed to the virtual network address, the FE selects the route with the lowest total cost (i.e., the highest priority).

In this context, the SD-WAN edge FEs at the branch networks use a combination of route weights from a combination of sources to identify total costs for routing data messages directed to the virtual network address to the different cloud datacenters across which the application resources are distributed. These route weights, in some embodiments, include geolocation route weights based on physical distances between the branch networks and the cloud datacenters, datacenter route weights that are updated in real time indicating capacity of the different cloud datacenters, and latency route weights indicating latencies for sending data messages between the branch networks and the cloud datacenters.

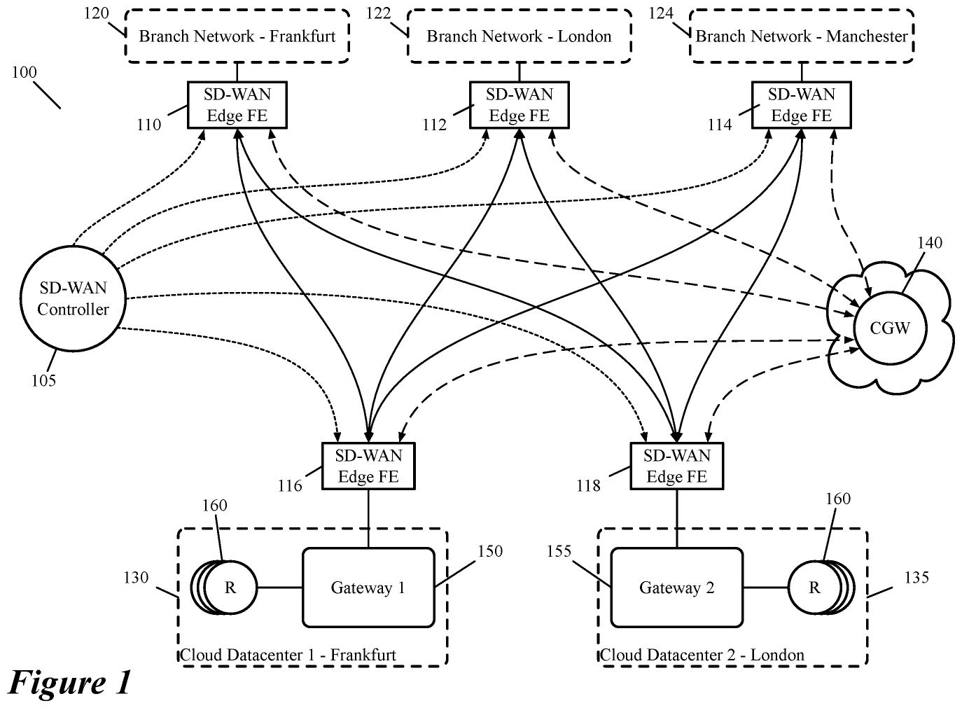

FIG. 1 illustrates a set of branch networks connected to a set of cloud datacenters through an SD-WAN of some embodiments. The SD-WAN 100 enables high performance and reliable branch network access across multiple different clouds, according to some embodiments. As shown, each of the branch networks 120, 122, and 124 are connected to the SD-WAN 100 by the SD-WAN edge FEs 110, 112, and 114, and each of the cloud datacenters 130-135 are connected to the SD-WAN by the SD-WAN edge FEs 116-118. Additionally, the SD-WAN 100 includes an SD-WAN controller 105 and a cloud gateway 140. In some embodiments, the elements of the SD-WAN 100 are in a full mesh topology in which each forwarding element is connected to every other forwarding element. In other embodiments, the SD-WAN elements are in partial mesh topologies.

The SD-WAN controller 105, in some embodiments, is a cluster of network managers and controllers that serves as a central point for managing (e.g., defining and modifying) configuration data that is provided to the edge FEs and/or gateways to configure some or all of the operations. In some embodiments, this SD-WAN controller 105 is in one or more public cloud datacenters, while in other embodiments it is in one or more private datacenters. In some embodiments, the SD-WAN controller 105 has a set of manager servers that defines and modifies the configuration data, and a set of controller servers that distributes the configuration data to the edge FEs, hubs (not shown) and/or gateways. In some embodiments, the SD-WAN controller 105 directs edge FEs (as well as hubs (not shown)) to use certain gateways (i.e., assigns a gateway to the edge forwarding elements and hubs). Additionally, as mentioned above and will be described further below, the SD-WAN controller 105 is also responsible for computing and distributing geolocation route weights to each of the SD-WAN edge FEs for use in route selection.

Each of the cloud datacenters 130-135 can be provided by the same or different providers, while each of the branch networks 120-124 belongs to the same entity, according to some embodiments. The branch networks 120-124, in some embodiments, are multi-machine sites of the entity. Examples of multi-machine sites of some embodiments include multi-user compute sites (e.g., branch offices or other physical locations having multi user computers and other user-operated devices and serving as source computers and devices for requests to other machines at other sites), datacenters (e.g., locations housing servers), etc. These multi-machine sites are often at different physical locations (e.g., different buildings, different cities, different states, etc.). In some embodiments, the cloud datacenters are public cloud datacenters, while in other embodiments the cloud datacenters are private cloud datacenters. In still other embodiments, the cloud datacenters may be a combination of public and private cloud datacenters. Examples of public clouds are public clouds provided by Amazon Web Services (AWS), Google Cloud Platform (GCP), Microsoft Azure, etc., while examples of entities include a company (e.g., corporation, partnership, etc.), an organization (e.g., a school, a non-profit, a government entity, etc.), etc.

Each of the cloud datacenters 130-135 includes a respective gateway 150-155 for connecting the cloud datacenters to the SD-WAN edge FEs 116-118. Additionally, a set of application resources 160 is distributed across the cloud datacenters 130-135. The SD-WAN edge FEs 110-114 of the branch networks 120-124 receive various types of route weights from other elements of the SD-WAN (e.g., the SD-WAN controller 105, cloud gateway 140, SD-WAN edge FEs 116-118) and use these route weights to compute total costs for each route between the branch network and a cloud datacenter in order to access the resources 160 at the cloud datacenters.

In some embodiments, additional SD-WAN gateways may be present and can include multi-tenant, stateless service gateways deployed in strategic points of presence (PoPs) across the globe. Some such gateways serve as gateways to various clouds and datacenters. Also, in some embodiments, other SD-WAN forwarding elements may be present, including additional edge devices located at other branch sites of the entity, as well as SD-WAN hub forwarding nodes that can be used to connect to other edge forwarding nodes of other branch sites (not shown) to each other, as well as to resources at a datacenter that hosts the hub forwarding node. Hub forwarding nodes, in some embodiments, use or have one or more service engines to perform services (e.g., middlebox services) on data messages that it forwards from one branch site to another branch site.

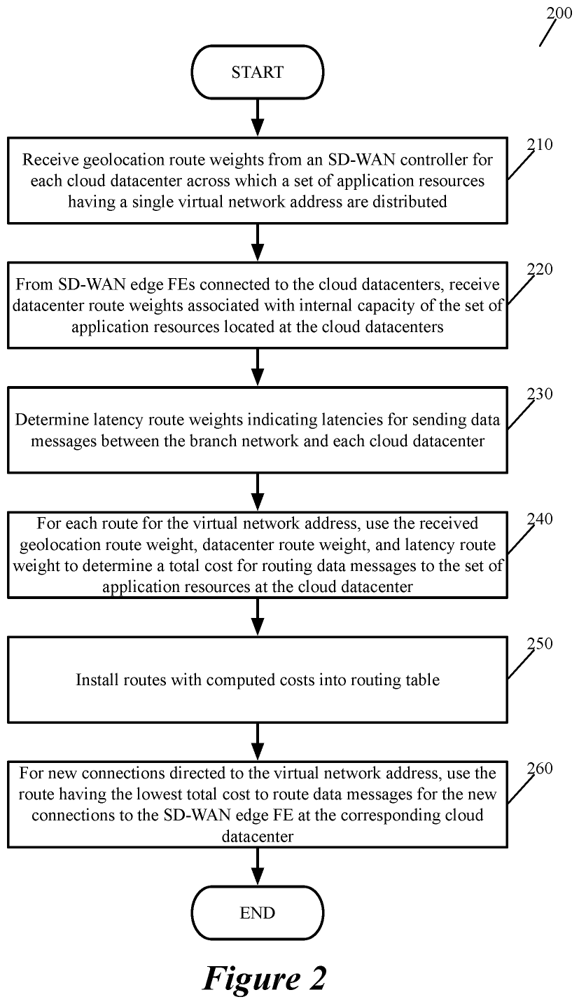

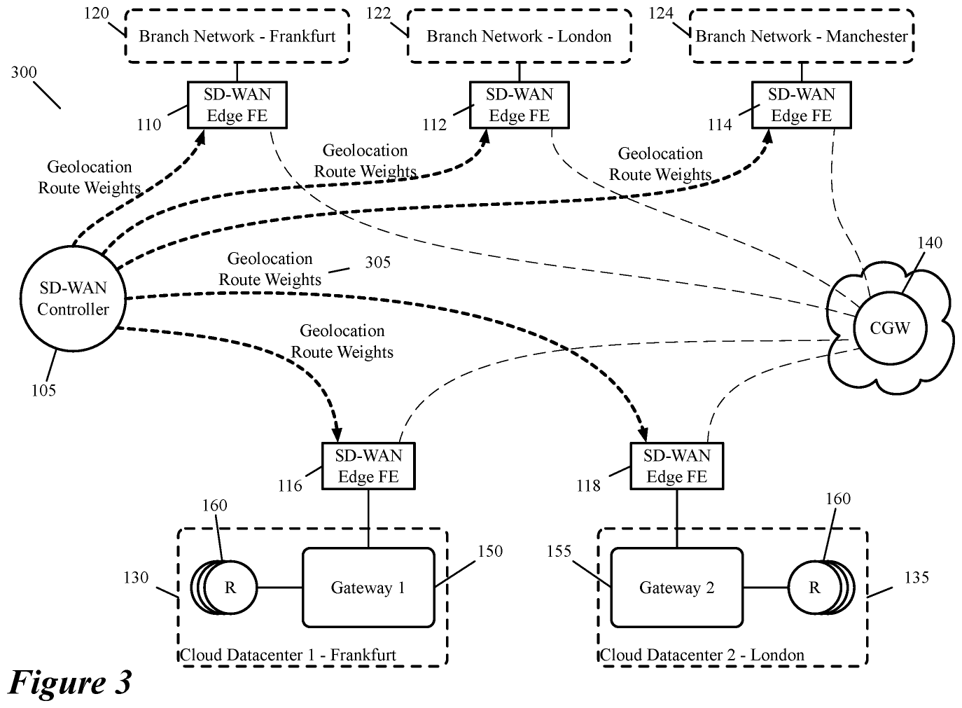

FIG. 2 conceptually illustrates a process of some embodiments for installing routes to cloud datacenters across which a set of application resources is distributed. The process 200 is performed by an SD-WAN edge FE located at a branch network. FIG. 2 will be described below with references to FIGS. 3, 4, and 5. The process 200 starts when the SD-WAN edge FE receives (at 210) geolocation route weights from an SD-WAN controller for each cloud datacenter across which the set of application resources is distributed.

For instance, FIG. 3 illustrates an SD-WAN 300 through which the SD-WAN controller 105 provides geolocation route weights 305 to the SD-WAN edge FEs 110-118. The geolocation route weights, in some embodiments, correspond to physical distances between the branch networks and the cloud datacenters (e.g., such that larger physical distances are expressed as larger route weights). The geolocation route weight for a route between the Frankfurt branch network 120 and the Frankfurt cloud datacenter 130 would be smaller than the geolocation route weight between the Frankfurt branch network 120 and the London cloud datacenter 135.

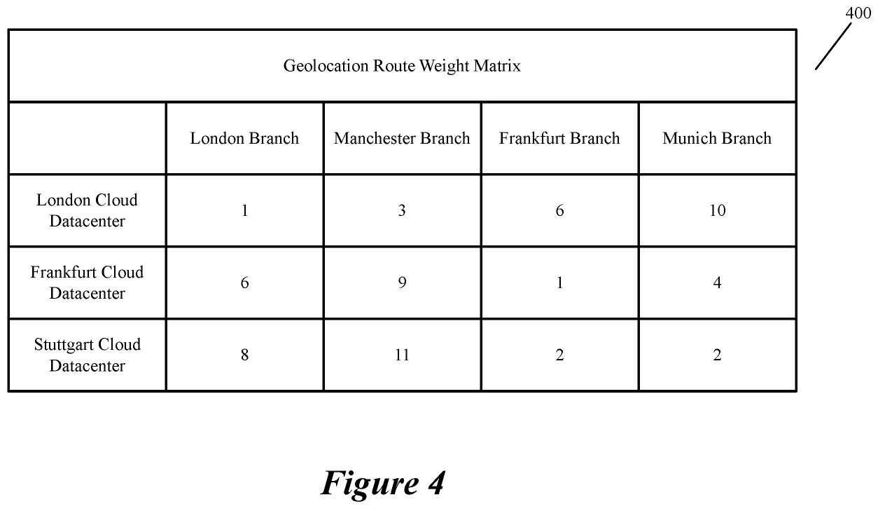

In some embodiments, the SD-WAN controller 105 generates these geolocation route weights as a matrix of route weights for each link between one of the branch networks and one of the cloud datacenters, such that each branch network SD-WAN edge FE receives the geolocation route weights for its link to each of the cloud datacenters. FIG. 4, for example, conceptually illustrates a geolocation route weight matrix 400 for a set of branch networks and a set of cloud datacenters. Each SD-WAN edge FE for each branch network, in some embodiments, receives such a geolocation route weight matrix 400 and uses the matrix to identify geolocation routes weights for use in calculating total costs for each route. The geolocation route weights are static values that remain unchanged over time, according to some embodiments. That is, the geolocation route weight of 3 specified by the matrix 400 for the route between the Manchester branch and the London datacenter, for example, will be 3 regardless of changes to any other metrics (e.g., datacenter and latency route weights).

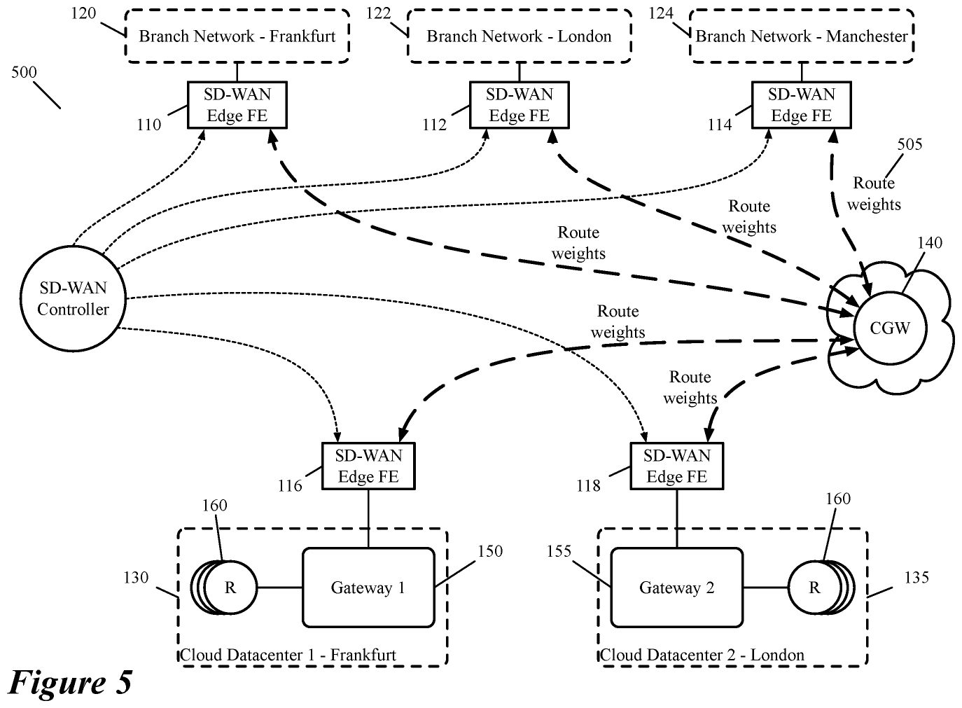

Returning to the process 200, the process next receives (at 220), from SD-WAN edge FEs connected to the cloud datacenters, datacenter route weights associated with internal capacity of the set of application resources located at the cloud datacenters. In some embodiments, larger route weights indicate less current capacity at the datacenter (i.e., a higher total cost, or lower priority, for the corresponding route). FIG. 5 illustrates the forwarding, in some embodiments, of initial datacenter route weights in an SD-WAN 500 from the SD-WAN edge FEs 116-118 at the cloud datacenters 130 and 135 to the SD-WAN edge FEs 110-114 at the branch networks 120-124.

In some embodiments, the initial route weights 505 are provided to the SD-WAN edge FEs at the branch networks from the SD-WAN edge FEs at the cloud datacenters via the cloud gateway 140. Once connections between the SD-WAN edge FEs at the branch networks and the SD-WAN edge FEs at the cloud datacenters have been established, different embodiments provide updates to the datacenter route weights to the SD-WAN edge FEs at the branch networks in different ways. Some embodiments continue to send these updates to the SD-WAN edge FEs at the branch networks via the cloud gateway 140, with the connections between edge FEs only used for data traffic. In other embodiments, however, the SD-WAN edge FEs at the cloud datacenters send updated route weights directly to the SD-WAN edge FEs at the branch networks once there is a connection established to those branch network SD-WAN edge FEs. As described further below, the SD-WAN edge FEs at the datacenters receive information for computing the route weights from load balancers at the datacenter.

The process 200 next determines (at 230) latency route weights indicating latencies for sending data messages between the branch network and each cloud datacenter. The latency route weights are computed by the SD-WAN edge FE at the branch network, in some embodiments, based on latency measurements between the SD-WAN edge FE at the branch and the SD-WAN edge FEs at the cloud datacenters. These measurements, in some embodiments, are determined using a dynamic multipath optimization technique, such as VeloCloud Multipath Protocol (VCMP). In other embodiments, the latency measurements may be based on actual data traffic sent between the branch networks and the cloud datacenters or on separate measurements (e.g., control messages sent for the purposes of computing the latency).

For each route for the virtual network address, the process uses (at 240) the received geolocation route weight, datacenter route weight, and latency route weight to determine a total cost for routing data messages to the set of application resources at the cloud datacenter. The total cost may be computed in different ways in different embodiments (e.g., using one route weight as a primary cost with others as tiebreakers, adding the route weights together, etc.).

In some embodiments, the geolocation route weight from the controller is a static value (because the physical distance is constant) as mentioned above, while the datacenter route weight and latency route weights are updated in real-time. The SD-WAN edge FE 110-114 at the branch network 120-124 may periodically update the total cost for a route based on real-time changes to either the latency route weight or the datacenter route weight (e.g., based on received updated datacenter routes weights). When the total cost of one or more of the routes at the SD-WAN edge for a particular branch network is changed such that a different one of the routes has the lowest total cost (highest priority), existing connections are not re-routed from one datacenter to another but any new connections originating from that branch network to the set of resources are routed to the datacenter whose route now has the lowest total cost.

The process installs (at 250) routes with the computed total costs into a routing table, and, for new connections directed to the virtual network address, uses (at 260) the route having the lowest total cost to route data messages for the new connections to the SD-WAN edge FE at the corresponding cloud datacenter. Because the total costs are updated periodically based on real-time changes to the latency and datacenter route weights, in some embodiments, each time a new connection directed to the virtual address is made, a different route may be selected. Following 260, the process 200 ends.

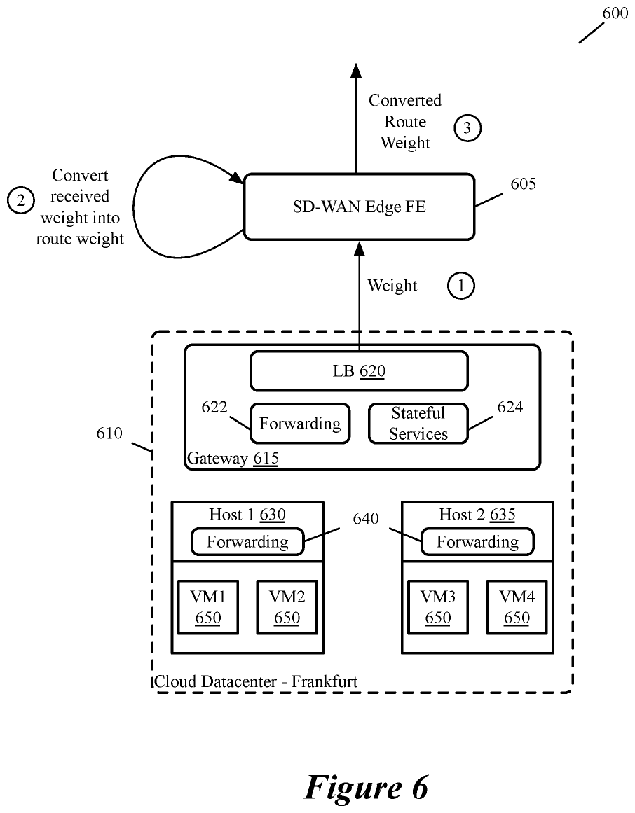

In some embodiments, before providing a datacenter route weight to the SD-WAN edge FEs at the branch networks, each SD-WAN edge FE connected to each cloud datacenter receives a message from the cloud datacenter specifying a weight metric for the virtual network address. FIG. 6 conceptually illustrates a workflow of some embodiments between such a cloud datacenter and an SD-WAN edge FE 605 connected to the cloud datacenter. As shown, the cloud datacenter 610 includes a gateway 615 and a set of host computers 630-635. The gateway 615 executes a load balancer 620, a forwarding device instance 622, and a stateful services instance 624, while each of the hosts 630-635 executes a respective forwarding device instance 640 and a set of VMs 650 (e.g., service VMs).

The datacenter 610 is one of multiple cloud datacenters that provide a set of application resources (e.g., a multicloud). In some embodiments, the cloud datacenter 610 may belong to more than one group of datacenters across which a set of application resources is distributed. That is, in some embodiments, a first subset of the VMs 650 are associated with one set of application resources, while a second subset of the VMs 650 are associated with a different set of application resources. In some such embodiments, each different set of application resources is reachable at a different virtual network address advertised by the datacenter 610.

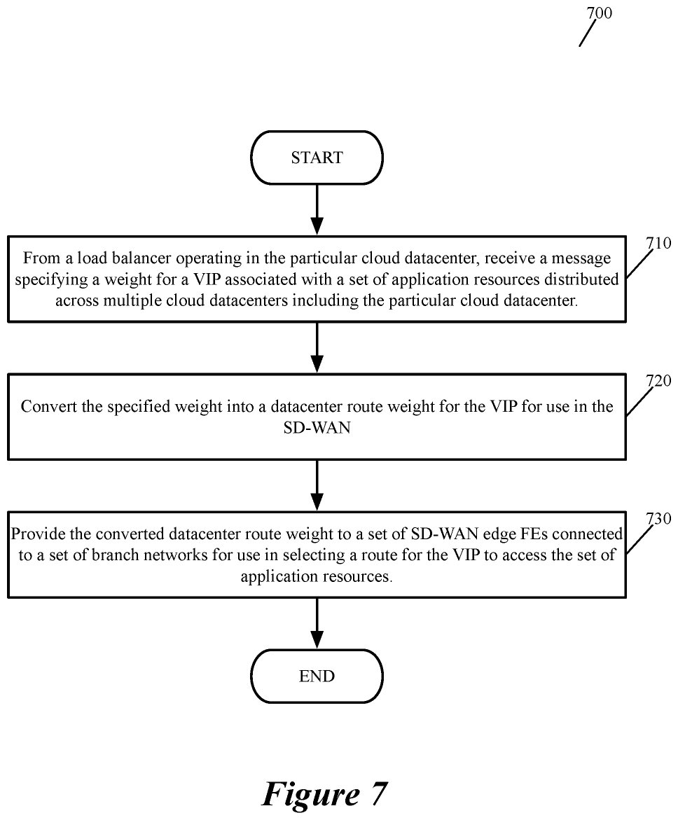

In order to prevent an overutilization or underutilization of the application resources provided by the datacenter 610, the load balancer 620 performs load balancing within the datacenter 610 for the VMs 650 distributed across the hosts 630 and 635, as well as load balancing for the datacenter as a whole (i.e., based on incoming connections to the datacenter). FIG. 6 will be further described below by reference to FIG. 7, which conceptually illustrates a process of some embodiments for providing the datacenter route weights to SD-WAN edge FEs at the branch networks. The process 700 is performed by an SD-WAN edge FE connected to a particular cloud datacenter.

The process 700 starts when the SD-WAN edge FE receives (at 710), from a load balancer operating in the particular cloud datacenter, a message specifying a weight for a virtual network address (e.g., virtual internet protocol (VIP) address) associated with a set of application resources distributed across multiple cloud datacenters including the particular cloud datacenter. For example, the SD-WAN edge FE 605 receives (at the encircled 1) a weight from the load balancer 620 operating on the gateway 615 in the cloud datacenter 610.

In some embodiments, the message received by the SD-WAN edge FE at the particular cloud datacenter is a border gateway protocol (BGP) message that advertises the virtual network address (e.g., VIP) and specifies the weight as a BGP community attribute. In other embodiments, other routing protocols or other types of messages may be used to communicate the weight. The load balancers of some embodiments are responsible for calculating and adjusting the weight metrics for each of the cloud datacenters based on the capacity of the application resources at their respective datacenters. That is, when the application resources at a particular cloud datacenter are overutilized, the load balancer at that datacenter can increase the weight metric so that subsequent new connections for the application resources are less likely to be forwarded to that datacenter. In some embodiments, the first weight specified for a VIP for each cloud datacenter is the same across all of the cloud datacenters, and each load balancer adjusts their datacenter's respective weight based on the subsequent number of connections.

The process 700 converts (at 720) the specified weight into a datacenter route weight for the VIP for use in the SD-WAN. In some embodiments, the SD-WAN edge FE converts this specified weight to a route weight in a type, length, value (TLV) format (e.g., a VeloCloud Routing Protocol (VCRP) route weight). The SD-WAN edge FE 605, for instance, is illustrated as converting (at the encircled 2) the weight received from the load balancer 620 into a datacenter route weight that can be used by other SD-WAN edge FEs as part of their route selection processes.

The process 700 provides (at 730) the converted datacenter route weight to a set of SD-WAN edge FEs connected to a set of branch networks for use in selecting a route to the VIP for accessing the set of application resources. For example, the SD-WAN edge FE 605 sends out (at the encircled 3) the converted datacenter route weight. In some embodiments, such as for initial datacenter route weights, the SD-WAN edge FE 605 forwards the converted datacenter route weight to a cloud gateway (e.g., cloud gateway 140) for delivery to the SD-WAN edge FEs at the branch networks, and forwards any subsequent updates directly to the SD-WAN edge FEs at the branch networks. Following 730, the process 700 ends.

In some embodiments, the load balancer in the cloud datacenter calculates the weight provided to the SD-WAN edge FE based on capacity measurements of DCNs that provide the application resources. The DCNs can include virtual machines (VMs), a container, and physical computers (e.g., servers) with identical hardware and software, according to some embodiments. The computations are performed, in some embodiments, by components of the load balancer (e.g., the layer-4 (L4) AVI Load Balancer from VMware, Inc.). From a set of DCNs (e.g., the VMs 650), the load balancer identifies a first subset of DCNs that includes DCNs that have a latency that is higher than an average latency computed for the set of DCNs and identifies a second subset of DCNs that includes DCNs that have a latency that is lower than the average latency computed for the set of DCNs. For each DCN in the first subset of DCNs, the load balancer assigns to the DCN a weight value that corresponds to a target latency computed for the set of DCNs. Based on the assigned weight values for the first subset of DCNs, the load balancer computes an excess weight value (i.e., the excess weight that remains after the weights have been reduced for the first subset of DCNs) and redistributes the excess weight value across the second subset of DCNs.

The average latency computed for the set of DCNs, in some embodiments, is computed by first determining, for each DCN in the set of DCNs, a rolling median latency for the DCN based on a set of ten most recent recorded latencies for the DCN at its current weight, and using the rolling median latencies for each DCN in the set of DCNs to compute an average latency for the set of DCNs. The target latency that is used to determine the reduced weights for the first subset of DCNs, in some embodiments, is equal to the average latency computed for the set of DCNs. In some embodiments, to assign the weight value that corresponds to the target latency, the components of the load balancer generate a map between weight values assigned to the DCN and latencies recorded at each of those weight values. The recorded latencies, in some embodiments, are representative of a rolling median calculated for the DCN at each weight value. In some embodiments, when an exact weight value for the target latency is not available in the map for a particular DCN, polynomial regression (i.e., a regression analysis modeling an independent variable and a dependent variable as an nth degree polynomial in the independent variable) is used to determine the weight value for the target latency.

To redistribute the computed excess weight value across the second subset of DCNs, in some embodiments, inverse differences must be computed for the second subset of DCNs. The inverse difference for each DCN corresponds to a percentage of the excess weight value that is to be redistributed to that DCN, according to some embodiments. The inverse difference for a DCN is calculated by first computing a difference between the average latency for the set of DCNs and a rolling median latency for the DCN at its current assigned weight (i.e., assigned first weight value), and dividing that difference by the sum of differences calculated for each DCN in the second subset. As a result, the excess weight is proportionally redistributed across the second subset of DCNs. The capacity-aware L4 load balancer and its functionalities are also described in commonly owned U.S. patent application Ser. No. 17/746,830, entitled “CAPACITY-AWARE LAYER-4 LOAD BALANCER,” filed on May 17, 2022. U.S. patent application Ser. No. 17/746,830 is incorporated herein by reference in its entirety.

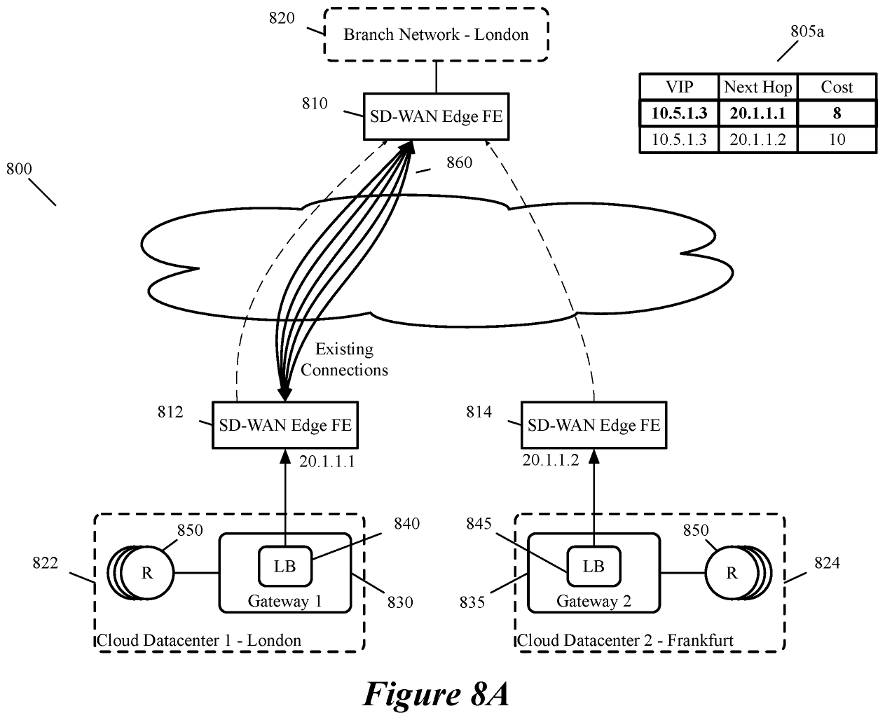

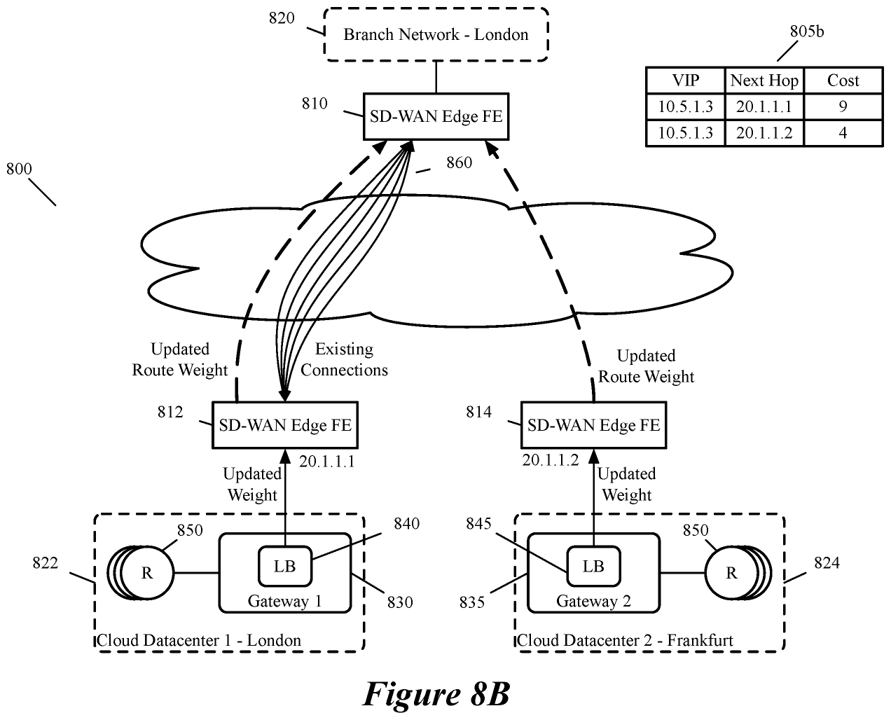

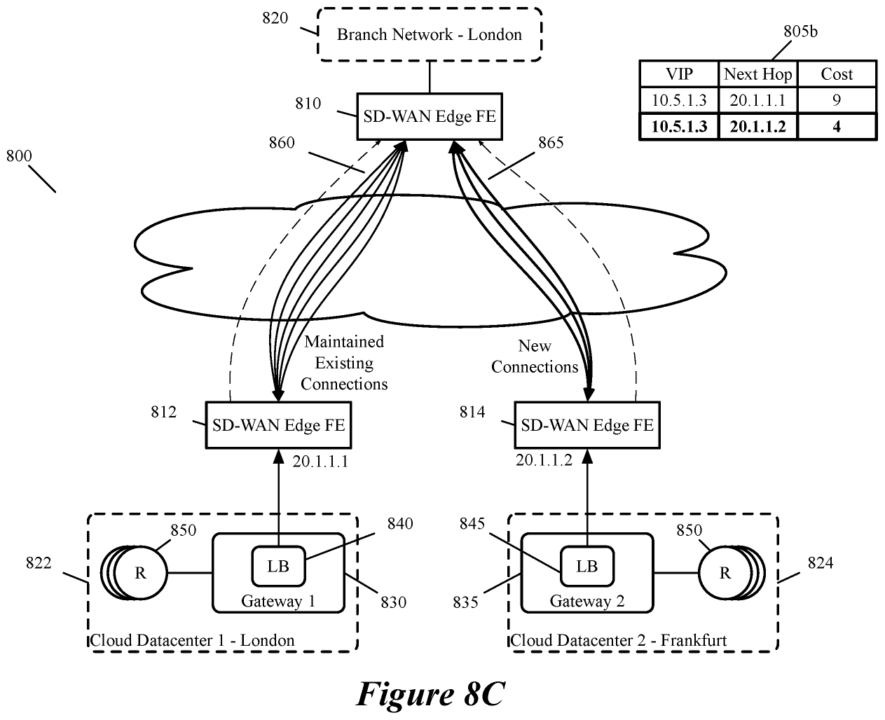

FIGS. 8A-8C conceptually illustrate an example of an SD-WAN across which sets of existing and new connections are established between a branch network and a set of cloud datacenters based on the total cost to route data messages between the branch network and each of the cloud datacenters. As shown, FIG. 8A illustrates an SD-WAN 800 through which an SD-WAN edge FE 810 at a branch network 820 can establish tunnels to SD-WAN edge FEs 812-814 at cloud datacenters 822-824 for accessing application resources 850 provided by each of the cloud datacenters 822-824. In addition to the resources 850, each of the cloud datacenters 822-824 includes a respective load balancer 840-845 that operates on a respective gateway 830-835.

As discussed above, the SD-WAN edge FE at the branch network 820 calculates the total costs for each route between the branch network 820 and each cloud datacenter 822-824. For instance, the routing table 805a includes total costs for routes between the branch network 820 and each of the cloud datacenters 822-824. The total costs, in some embodiments, are calculated using a combination of the datacenter route weights, latency route weights, and geolocation route weights specified for the routes. For instance, in some embodiments, the total cost of a route is the sum of the datacenter, latency, and geolocation route weights. In other embodiments, one route weight is selected as a primary cost, and the other route weights are used as tie breakers. For instance, in some embodiments, the geolocation route weights are used as the primary route weights, and if two routes have the same geolocation route weight, the route having a lower latency and/or datacenter route weight is selected. In still other embodiments, other combinations of the route weights may also be used.

The routing table 805a, as mentioned above, includes total costs for each route between the branch network 820 and a cloud datacenter 822-824. For instance, the route between the branch network 820 (with its location specified as London) and the cloud datacenter 822 (with its location also specified as London) has a total cost of 8, while the route between the branch network 820 and the cloud datacenter 824 (with its location specified as Frankfurt) has a total cost of 10. Accordingly, the set of existing connections 860 are established between the SD-WAN edge FE 810 for the branch network 820 and the SD-WAN edge FE 812 at the cloud datacenter 822.

FIG. 8B conceptually illustrates the SD-WAN 800 as the SD-WAN edge FEs 812-814 receive updated weights from the load balancers 840-845 in the respective cloud datacenters 822-824, and provide converted updated datacenter route weights to the SD-WAN edge FE 810 at the branch network 820. After the SD-WAN edge FE 810 receives the updated datacenter route weights, new total costs are calculated for each of the routes and the table 805b is updated with the new total costs. As shown, the new total cost for the route between the branch network 820 and the cloud datacenter 822 has increased from 8 to 9, while the total cost for the route between the branch network 820 and the cloud datacenter 824 has decreased from 10 to 4.

In some embodiments, the datacenter route weight changes are based on an overutilization and/or an underutilization of resources at one or more cloud datacenters. For instance, in this example, the load balancer 840 in the cloud datacenter 822 may determine that the number of connections the SD-WAN edge FE 810 for the branch network 820 has established with the SD-WAN edge FE 812 for the cloud datacenter 822 exceeds a threshold number of connections, and as a result, increases the weight for the datacenter 822. Conversely, the load balancer 845 in the cloud datacenter 824 may determine that its datacenter resources 850 are underutilized and, in turn, reduce the weight for the datacenter 824 in order to attract more connections.

Finally, FIG. 8C illustrates the SD-WAN 800 after the SD-WAN edge FE 810 at the branch network 820 has established new connections 865 to the SD-WAN edge FE 814 at the cloud datacenter 824 based on the updated total costs specified in the table 805b for routing data messages to the cloud datacenters 822-824. Despite the new connections 865 being established with the SD-WAN edge FE 814 at the datacenter 824, the existing connections 860 to the SD-WAN edge FE 812 at the datacenter 822 are maintained.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

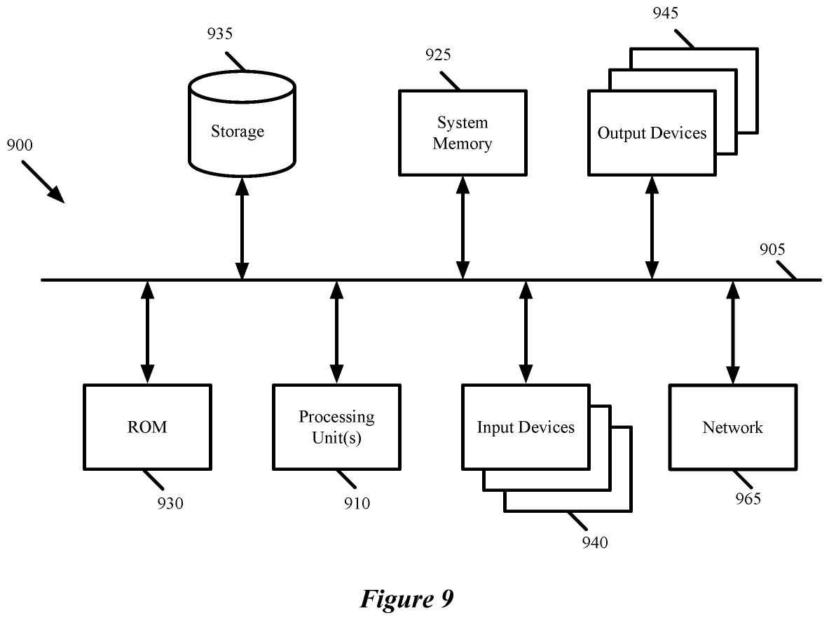

FIG. 9 conceptually illustrates a computer system 900 with which some embodiments of the invention are implemented. The computer system 900 can be used to implement any of the above-described hosts, controllers, gateway, and edge forwarding elements. As such, it can be used to execute any of the above described processes. This computer system 900 includes various types of non-transitory machine-readable media and interfaces for various other types of machine-readable media. Computer system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the computer system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) 910 may be a single processor or a multi-core processor in different embodiments. The read-only-memory (ROM) 930 stores static data and instructions that are needed by the processing unit(s) 910 and other modules of the computer system 900. The permanent storage device 935, on the other hand, is a read-and-write memory device. This device 935 is a non-volatile memory unit that stores instructions and data even when the computer system 900 is off. Some embodiments of the invention use a mass-storage device (such as a magnetic or optical disk and its corresponding disk drive) as the permanent storage device 935.

Other embodiments use a removable storage device (such as a floppy disk, flash drive, etc.) as the permanent storage device. Like the permanent storage device 935, the system memory 925 is a read-and-write memory device. However, unlike storage device 935, the system memory 925 is a volatile read-and-write memory, such as random access memory. The system memory 925 stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices 940 enable the user to communicate information and select commands to the computer system 900. The input devices 940 include alphanumeric keyboards and pointing devices (also called “cursor control devices”). The output devices 945 display images generated by the computer system 900. The output devices 945 include printers and display devices, such as cathode ray tubes (CRT) or liquid crystal displays (LCD). Some embodiments include devices such as touchscreens that function as both input and output devices 940 and 945.

Finally, as shown in FIG. 9, bus 905 also couples computer system 900 to a network 965 through a network adapter (not shown). In this manner, the computer 900 can be a part of a network of computers (such as a local area network (“LAN”), a wide area network (“WAN”), or an Intranet), or a network of networks (such as the Internet). Any or all components of computer system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of implementing context-aware routing for a software-defined wide-area network (SD-WAN), the method comprising:
at a particular SD-WAN edge forwarding element (FE) connected to a particular cloud datacenter:
receiving a message specifying a weight for a virtual network address associated with a set of application resources distributed across a plurality of cloud datacenters including the particular cloud datacenter;
converting the specified weight into a route weight for the SD-WAN; and
providing the converted route weight to a set of SD-WAN edge FEs connected to a set of branch networks, wherein each SD-WAN edge FE in the set of SD-WAN edge FEs uses the provided route weight to calculate a total cost for routing data messages directed to the virtual network address to the particular cloud datacenter.

2. The method of claim 1, wherein the message is a border gateway protocol (BGP) message advertising the virtual network address with the weight specified as a BGP community attribute.

3. The method of claim 1, wherein converting the specified weight into a route weight for the SD-WAN comprises converting the specified weight to a VCRP (VeloCloud Routing Protocol) route weight TLV (type, length, value).

4. The method of claim 1, wherein the message is a first message and the weight is a first weight, the method further comprising:
receiving a second message specifying an updated second weight for the virtual network address;
converting the updated second weight into a second route weight for the SD-WAN; and
providing the converted second route weight to the set of SD-WAN edge FEs connected to the set of branch networks, wherein each SD-WAN edge FE in the set of SD-WAN edge FEs uses the provided second route weight to calculate an updated total cost for routing data messages directed to the virtual network address to the particular cloud datacenter.

5. The method of claim 4, wherein at least one SD-WAN edge FE connected to a first branch network begins sending data messages for new connections to a different cloud datacenter in the plurality of cloud datacenters rather than the particular cloud datacenter based on the updated total cost for routing data messages directed to the virtual network address to the particular cloud datacenter.

6. The method of claim 4, wherein at least one SD-WAN edge FE connected to a first branch network begins sending data messages for new connections to the particular cloud datacenter rather than a different cloud datacenter in the plurality of cloud datacenters based on the updated total cost for routing data messages directed to the virtual network address to the particular cloud datacenter.

7. The method of claim 1, wherein the message is received from a load balancer executing on a computing device in the particular cloud datacenter.

8. The method of claim 7, wherein the load balancer computes the specified weight based on a capacity metric calculated within the particular cloud datacenter.

9. The method of claim 1, wherein:
the virtual network address is advertised by each of the plurality of cloud datacenters; and
each cloud datacenter of the plurality of cloud datacenters specifies a respective weight associated with the respective cloud datacenter for the virtual network address to a respective edge SD-WAN edge FE connected to the respective cloud datacenter.

10. The method of claim 1, wherein the total cost for routing data messages directed to the virtual network address to the particular cloud datacenter is calculated by each SD-WAN edge FE in the set of SD-WAN edge FEs connected to the set of branch networks using a set of metrics comprising at least the provided route weight and a geolocation route weight associated with a physical distance between the particular cloud datacenter and a branch network to which the SD-WAN edge FE is connected.

11. The method of claim 10, wherein each SD-WAN edge FE in the set of SD-WAN edge FEs connected to the set of branch networks (i) identifies a lowest total cost for routing data messages directed to the virtual network address and (ii) establishes one or more connections to the application resources at the cloud datacenter associated with the identified lowest total cost for accessing the set of application resources.

12. A non-transitory machine readable medium storing a program for a particular SD-software-defined wide-area network (SD-WAN) edge forwarding element (FE) connected to a particular cloud datacenter, the program for execution by at least one processing unit, the program for implementing context-aware routing for an SD-WAN, the program comprising sets of instructions for:
receiving a message specifying a weight for a virtual network address associated with a set of application resources distributed across a plurality of cloud datacenters including the particular cloud datacenter;
converting the specified weight into a route weight for the SD-WAN; and
providing the converted route weight to a set of SD-WAN edge FEs connected to a set of branch networks, wherein each SD-WAN edge FE in the set of SD-WAN edge FEs uses the provided route weight to calculate a total cost for routing data messages directed to the virtual network address to the particular cloud datacenter.

13. The non-transitory machine readable medium of claim 12, wherein the message is a border gateway protocol (BGP) message advertising the virtual network address with the weight specified as a BGP community attribute.

14. The non-transitory machine readable medium of claim 12, wherein the set of instructions for converting the specified weight into a route weight for the SD-WAN comprises a set of instructions for converting the specified weight to a VCRP (VeloCloud Routing Protocol) route weight TLV (type, length, value).

15. The non-transitory machine readable medium of claim 12, wherein the message is a first message and the weight is a first weight, the program further comprising sets of instructions for:
receiving a second message specifying an updated second weight for the virtual network address;
converting the updated second weight into a second route weight for the SD-WAN; and
providing the converted second route weight to the set of SD-WAN edge FEs connected to the set of branch networks, wherein each SD-WAN edge FE in the set of SD-WAN edge FEs uses the provided second route weight to calculate an updated total cost for routing data messages directed to the virtual network address to the particular cloud datacenter.

16. The non-transitory machine readable medium of claim 15, wherein at least one SD-WAN edge FE connected to a first branch network begins sending data messages for new connections to a different cloud datacenter in the plurality of cloud datacenters rather than the particular cloud datacenter based on the updated total cost for routing data messages directed to the virtual network address to the particular cloud datacenter.

17. The non-transitory machine readable medium of claim 15, wherein at least one SD-WAN edge FE connected to a first branch network begins sending data messages for new connections to the particular cloud datacenter rather than a different cloud datacenter in the plurality of cloud datacenters based on the updated total cost for routing data messages directed to the virtual network address to the particular cloud datacenter.

18. The non-transitory machine readable medium of claim 12, wherein the message is received from a load balancer executing on a computing device in the particular cloud datacenter.

19. The non-transitory machine readable medium of claim 18, wherein the load balancer computes the specified weight based on a capacity metric calculated within the particular cloud datacenter.

20. The non-transitory machine readable medium of claim 12, wherein:
the virtual network address is advertised by each of the plurality of cloud datacenters; and
each cloud datacenter of the plurality of cloud datacenters specifies a respective weight associated with the respective cloud datacenter for the virtual network address to a respective edge SD-WAN edge FE connected to the respective cloud datacenter.

21. The non-transitory machine readable medium of claim 12, wherein the total cost for routing data messages directed to the virtual network address to the particular cloud datacenter is calculated by each SD-WAN edge FE in the set of SD-WAN edge FEs connected to the set of branch networks using a set of metrics comprising at least the provided route weight and a geolocation route weight associated with a physical distance between the particular cloud datacenter and a branch network to which the SD-WAN edge FE is connected.

22. The non-transitory machine readable medium of claim 21, wherein each SD-WAN edge FE in the set of SD-WAN edge FEs connected to the set of branch networks (i) identifies a lowest total cost for routing data messages directed to the virtual network address and (ii) establishes one or more connections to the application resources at the cloud datacenter associated with the identified lowest total cost for accessing the set of application resources.
